(19) United States
(12) Patent Application Publication
(10) Pub. No.: US 2012/0128400 A1
(43) Pub. Date: May 24, 2012

(54) Margarine, and similar products, dispenser and holder

(76) Inventor: Margareta Shahar, Tel Aviv (IL)

(21) Appl. No.: 13/373,549

(22) Filed: Nov. 18, 2011

(30) Foreign Application Priority Data
Apr. 29, 2010 (IL) PCT/IL2010/000345

(51) Int. Cl. B05C 11/02

(52) U.S. Cl. 401/89

(57) ABSTRACT

A margarine dispenser comprising a dispenser body that is shaped as a hollow tube with a top that is either partially or entirely open, and a movable top cover that functions as a piston; the bottom cover of the dispenser body has holes through which the margarine is pushed out in order to be used.

### TECHNICAL FIELD

The present invention relates to margarine and similar products dispenser. The dispenser contains main dispenser body, which will be filled up in margarine, internal bar, top and bottom cover and silicon slices in the bottom of the dispenser to allow spreading of margarine in a smooth and clean way.

### BACKGROUND ART

Heretofore, the invention relates to various food material that similar to margarine, and more particularly to a dispenser that allows spreading of margarine in a clean and smooth way.

The current situation is that customers buy margarine in a soft pack. The current pack will force the customer to take the margarine and when spreading it will cause dirt and un-sanitaria in the cooking area.

the present invention represents a novel dispenser that allows controlling the quantity of margarine being used and allowing the user to spread the margarine in a smooth and clean way.

In view of the needs, many solutions have been proposed. As example. U.S. Pat. No. 2,845,707 by Benjamin Redmond, and U.S. Pat. No. 2,980,247 by Robert R. Di Giantomasso. Pat no. US00D347366S by Larry Harmen & Mildred Harmen.

The above mentioned patent are not considered relevant because they consider methods of holding and dispensing margarine, or similar products, that describes general dispensers for soft materials. The descriptions provided in the above mentioned patents are related to the dispensers only, and not to the solution of spreading the margarine in a smooth manner.

In addition. U.S. Pat. No. 2,589,000 by Vani Eugene, and U.S. Pat. No. 3,920,156 by Leslie E. Hicks, are representing different methods to contain margarine (or similar products) and does not refer to the method of spreading the margarine.

None of the mentioned patent, or applications, related to a novel solution that describe the method of spreading the margarine, or similar products, in the same way that describes in this application.

### SUMMARY OF INVENTION

An object of the present invention is to provide a novel margarine dispenser, which will contain main dispenser body full of margarine, top cover and an internal bar. And bottom cover.

Another object of the present invention is to provide a novel solution of the way the margarine will exit the dispenser body.

Yet another object of the present invention is to represent a novel way that will allow smooth spreading of the margarine on the designated area.

It should be understood from the above description that the object of the present invention is to provide a margarine dispenser that comprises the dispenser body (50) and a top cover part (51). The dispenser body (50) is in fact a hollow body that is closed on all sides and is open (partially or entirely) on the top, and which has holes (55) on the bottom. The cover part (51) is designed to move through the dispenser body (50) thus pushing the margarine out through the holes (55) in the bottom (52) of the dispenser body (50). The basic and the simplest version of the margarine dispenser, subject of this invention, is composed of these two parts: The dispenser body (50) and the moving top cover (51), which functions as a top cover and as a kind of piston that pushes the margarine out of the dispenser.

### BRIEF DESCRIPTION OF DRAWINGS

FIG. 1 is a perspective view of the margarine dispenser.

FIG. 2 is a front and side plan view of FIG. 1.

FIG. 3 is section cut of FIG. 2. FIG. 3 represents cut in section A-A and B-B. in addition, FIG. 3 represent the top view of the dispenser.

FIG. 4 is a perspective view of the dispenser, without the top and bottom cover.

FIG. 5 is a front and side plan view of FIG. 4.

FIG. 6 is related to FIG. 5 and represent cut C-C. FIG. 6 is represented as there is no butter (or margarine) in the dispenser body to allow to see the top side of the bottom of the dispenser body.

FIG. 7 is a top and bottom view of FIG. 5.

FIGS. 8-20 describe another version of the invention.

### GENERAL DESCRIPTION

One who read this description, and the current application, must not consider the author way of expression as fact and must consider the description as novel concept for margarine, or similar products, dispenser and the way the margarine will be spread in the designated area.

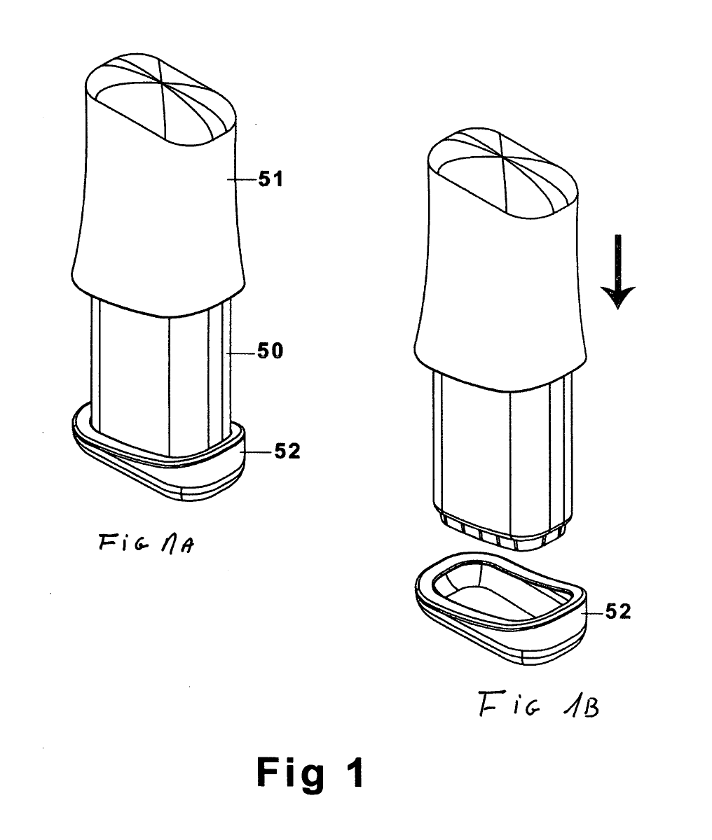

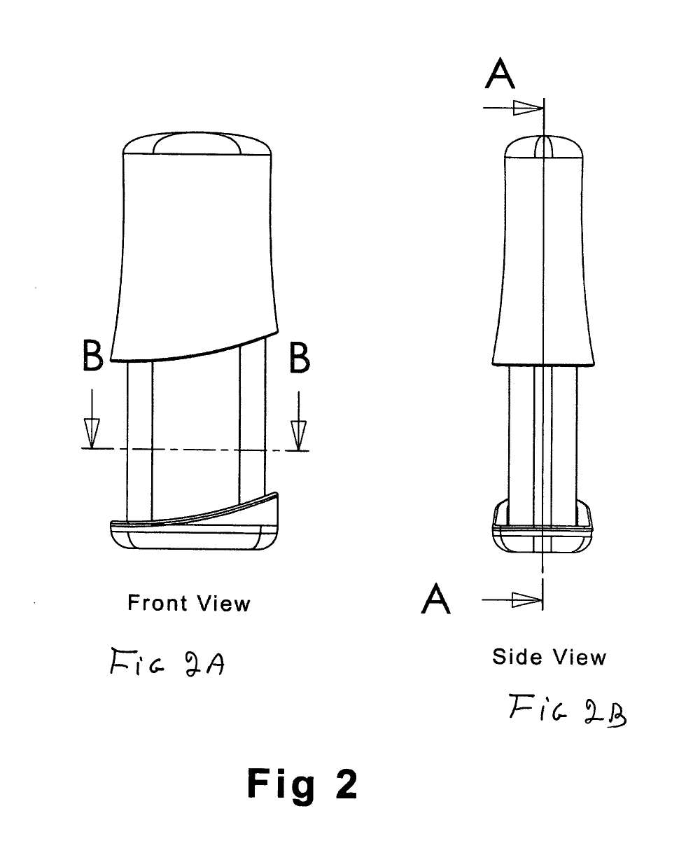

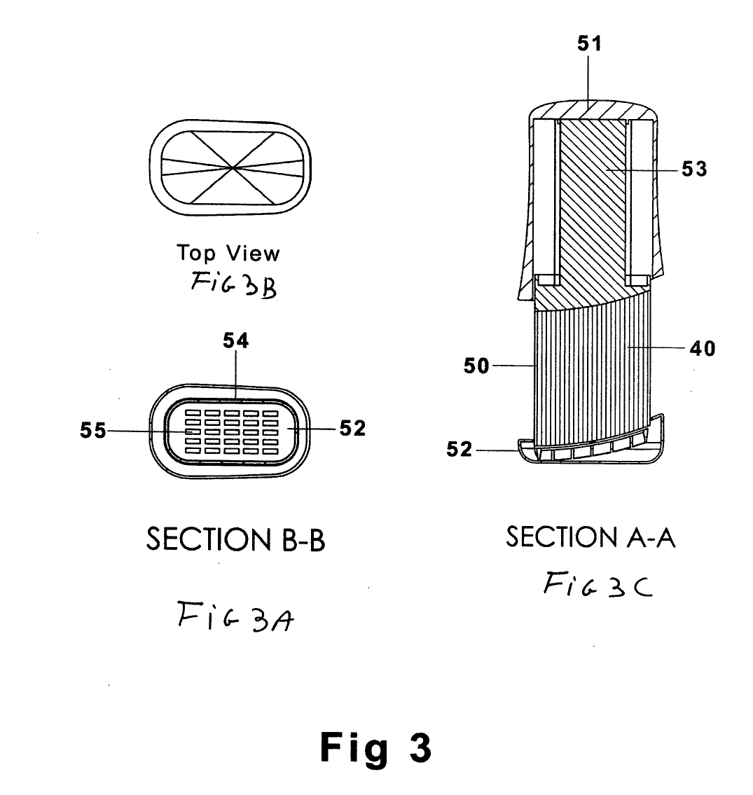

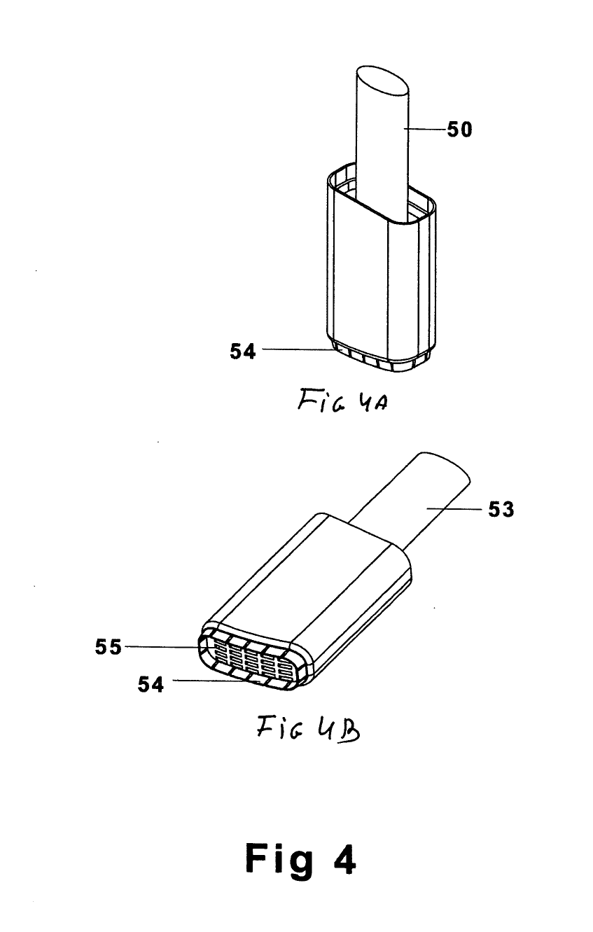

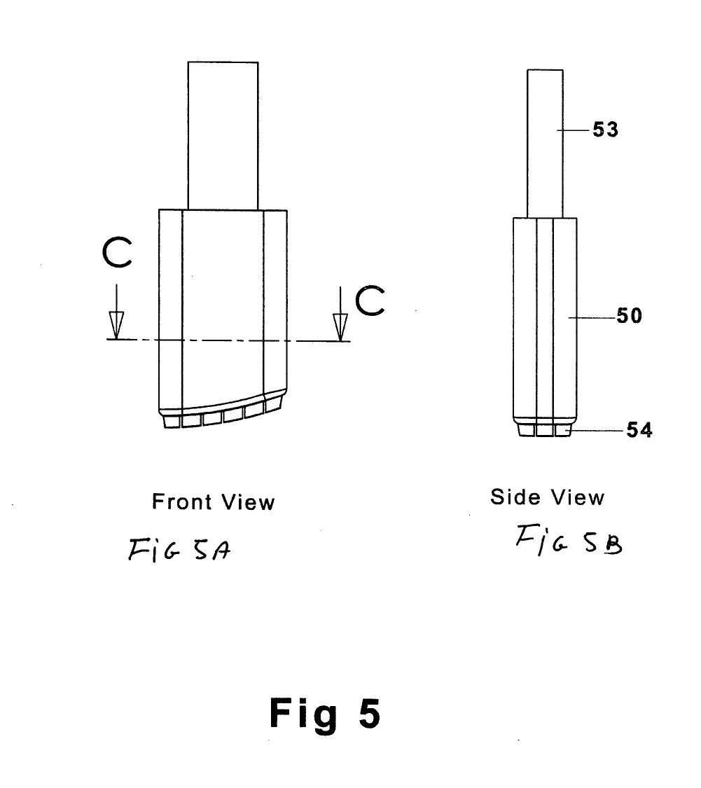

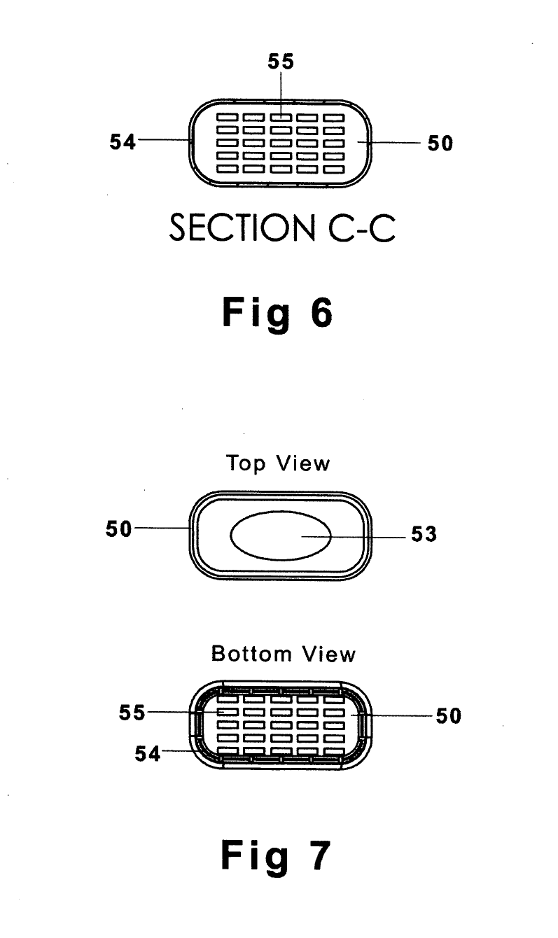

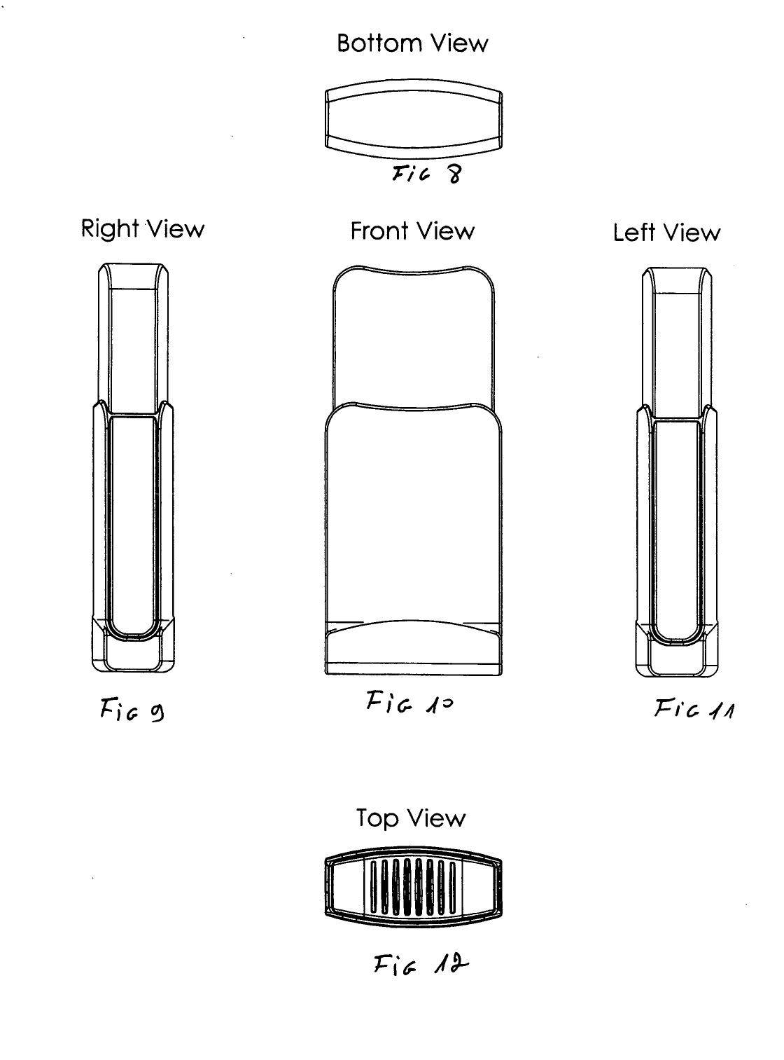

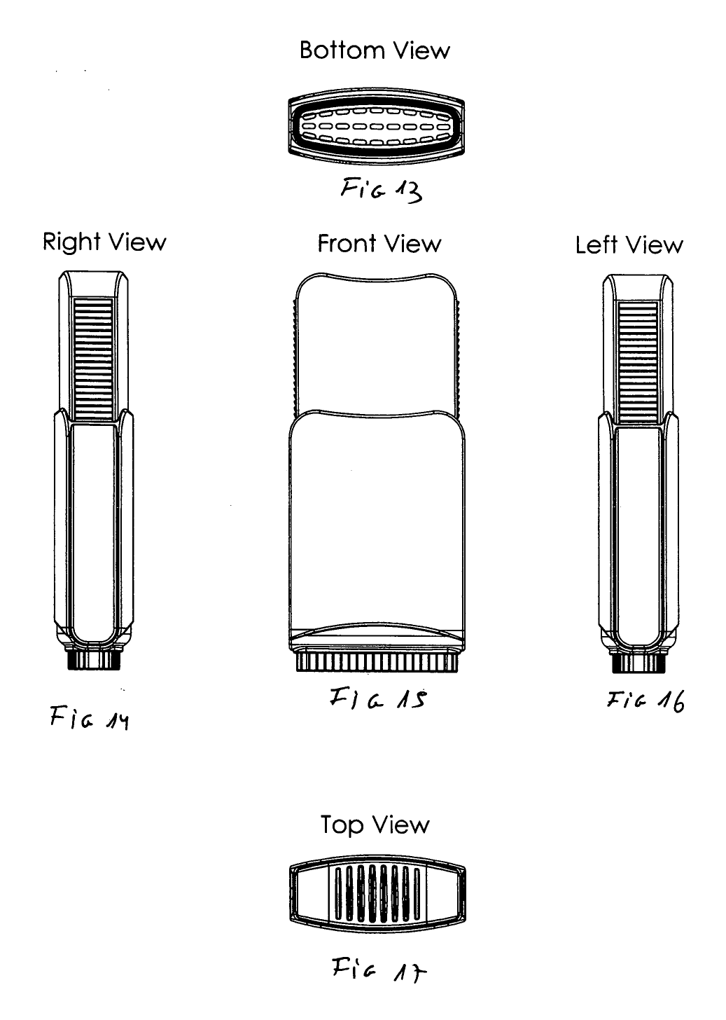

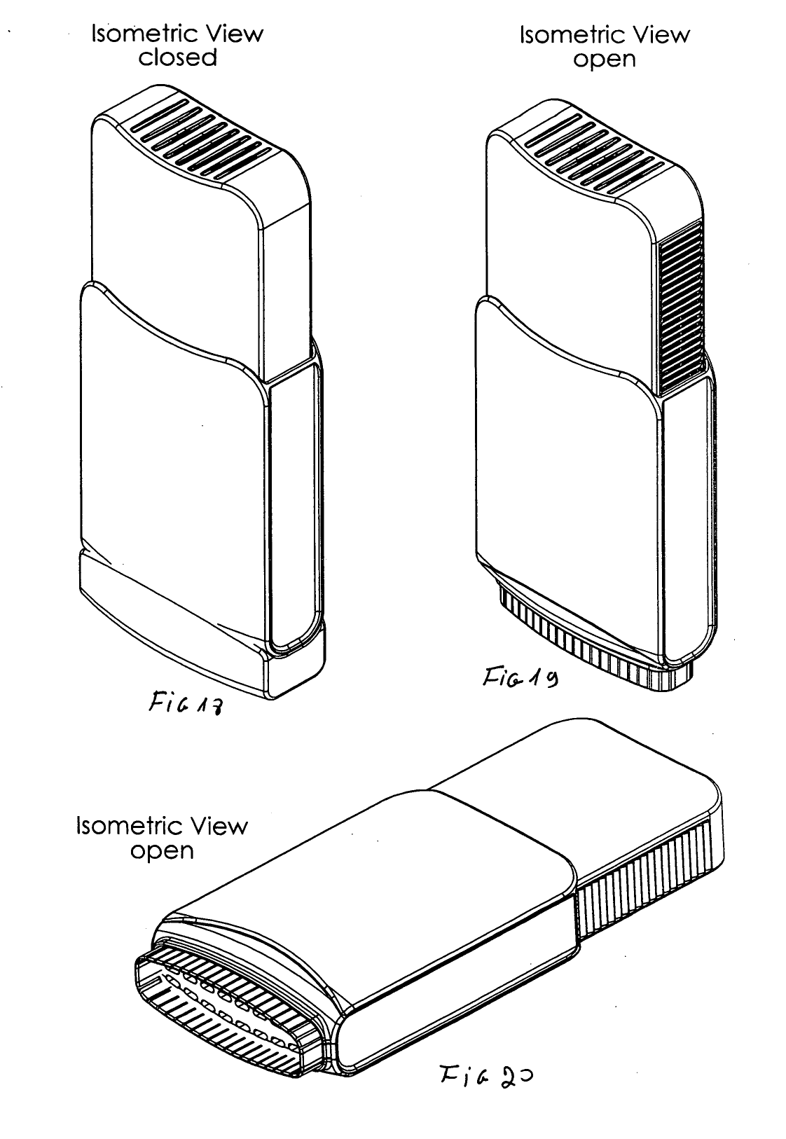

FIG. 1 is a perspective view of the dispenser, which contains the dispenser body 50, the top cover 51 and the bottom cover 52. When the dispenser will be in use the user will open the bottom cover 52, and lay the silicon slices FIG. 4, 54, on the designated area. By holding the top cover 51 and pushing down the margarine FIG. 3, Section A-A, 40, which located in the dispenser body 50, will force to exit through the holes FIG. 3, Section B-B, 55, in the bottom of the dispenser body FIG. 1, 50.

when the margarine 40, exit the holes 55, in the bottom of the dispenser body 50, the silicon slices FIG. 4, 54, will spread the margarine in the designated area in a smooth and clean way.

when using the dispenser, and pushing the top cover 51, down in the same direction as the arrow in FIG. 1, the internal bar FIG. 4, 53, will push the margarine 40, out of the bottom holes FIG. 4, 55, and the dispenser body 50, will be slide into the top cover 51. This will allow the margarine 40, that located in the dispenser body 50, to exit the holes 55, which located in the bottom side of the dispenser body 50. The internal bar FIG. 3, 53, is connected to the top cover 51, and when being pushed down will slide into the internal gap of the dispenser body 50.

when the margarine 40, will exit the holes 55, the silicon slices FIG. 3 & FIG. 7, 54, will spread the margarine in a smooth way.

at the end of spreading process the bottom cover 52, may be re-attached to the bottom of the dispenser body 50, to allow storage of the dispenser and the remaining of the margarine.

One who read this description, and the current application, must not consider the author way of expression, and the relevant drawings, as fact and must consider the description as novel concept for margarine, or similar products, dispenser and the way the margarine will be spread in the designated area. As an expansion to the novelty describes in this application the silicon slices FIG. 4, 54, may be located in a different, or addition, locations in the bottom side of the dispenser body 50, and may be located between the holes 55, around them, or on top of them, or in any other location in the bottom of the dispenser body 50.

With respect to the above description than, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modifications and equivalents may be resorted to, falling within the scope of the invention.

I claim:

1. A margarine, or similar product, dispenser that contains top cover, internal bar, dispenser body, bottom cover, holes in the bottom of the dispenser body and silicon slices, allows to control the amount of margarine being pushed out the holes.

2. A margarine, or similar product, dispenser that contains top cover, internal bar, dispenser body, bottom cover, holes in the bottom of the dispenser body and silicon slices, allows spreading margarine (or similar materials) in a smooth way on a designated area; The spreading will be done by moving the dispenser manually, when the silicon slices will spread the margarine that exit the holes.

3. The combination of halls in the bottom of the dispenser body together with silicon slices will provide novel solution to spread margarine, in a designated area, in a smooth layer.

4. The combination of halls in the bottom of the dispenser body together with silicon slices and in parallel top cover and an internal bar that will be pushed down, will allow the margarine to exit the bottom holes and being spread on a surface due to the silicon slices.

5. A margarine dispenser comprising a dispenser body that is shaped as a hollow tube with a top that is either partially or entirely open, and a movable top cover that functions as a piston; the bottom cover of the dispenser body has holes through which the margarine is pushed out in order to be used.
